(19) United States
(12) Patent Application Publication
(10) Pub. No.: US 2020/0266495 A1
(43) Pub. Date: Aug. 20, 2020

(54) LEAD STORAGE BATTERY

(71) Applicant: GS Yuasa International Ltd., Kyoto-shi, Kyoto (JP)

(72) Inventors: Hideharu TAKEZAWA, Osaka (JP); Atsumu IMASATO, Osaka (JP); Yasunori BABA, Osaka (JP)

(21) Appl. No.: 16/061,529

(22) PCT Filed: Dec. 13, 2016
(86) PCT No.: PCT/JP2016/087078

§ 371 Date: Jun. 12, 2018

(30) Foreign Application Priority Data
Dec. 25, 2015 (JP) 2015-255205

(51) Int. Cl. H01M 10/08; H01M 4/66; H01M 4/68; H01M 2/28; H01M 4/73

(52) U.S. Cl. CPC H01M 10/08; H01M 4/662; H01M 4/68; H01M 2004/027; H01M 4/73; H01M 2300/0011; H01M 2/28

(57) ABSTRACT

Disclosed is a lead acid battery including: a positive electrode; a negative electrode; a separator interposed between the positive electrode and the negative electrode; and an electrolyte containing sulfuric acid. The negative electrode includes a negative electrode active material, and a negative electrode grid that supports the negative electrode active material. The negative electrode grid contains tin in an amount of 0.1 mass % or more and 0.8 mass % or less. The electrolyte contains aluminum ions at a concentration of 1 mmol/L or more and less than 10 mmol L, and sodium ions at a concentration of 15 mmol/L or less.

### TECHNICAL FIELD

The present invention relates to a lead acid battery.

### BACKGROUND ART

Lead acid batteries, which are inexpensive, have a relatively high battery voltage, and provide a large amount of power, have various applications, such as use as starter motors for automobiles. A lead acid battery includes a positive electrode containing lead dioxide, a negative electrode containing lead, a separator interposed between the positive electrode and the negative electrode, and an electrolyte containing sulfuric acid.

In automobile applications in recent years, a lead acid battery is often used in an underduuge state in which the state of charge (SOC) is about 90 to 70%, such as when the vehicle is in an idle stop state. If the battery is continuously used in an underdcharge state as described above, due to deactivation of the negative electrode active material called sulfation, the charge acceptance decreases, which accelerates the degradation of the battery. This is because, when the battery is in a chronically insufficient charge state, lead sulfate is gradually crystallized, and an electrochemical activity is lost. Crystalline lead sulfate is less soluble in an electrolyte, and thus the polarization of the charge reaction in the negative electrode increases. As a result of a reduction in the charge acceptance of the negative electrode, the charge capacity (charge efficiency) in a limited charge time is reduced, which makes it difficult for the SOC to recover. Accordingly, when the undercharge state continues, the SOC further decreases, and the battery degrades.

To address the problem described above, various improvements have been attempted to improve the charge acceptance of the negative electrode or increase the charge efficiency.

Patent Literature 1 teaches that adding aluminum ions, selenium ions, titanium ions, sodium ions or the like at a predetermined concentration to an electrolyte improves the charge efficiency, and suppresses the degradation of the active material. Patent Literature 1 discloses that the concentration of aluminum ions in the electrolyte is 10 mmol/L to 300 mmol/L, and the concentration of sodium ions is 2 mmol/L to 50 mmol/L.

### CITATION LIST

### Patent Literature

[PTL 1] WO 2007/036979

### SUMMARY OF INVENTION

### Technical Problem

As disclosed in Patent Literature 1, when the concentration of aluminum ions in the electrolyte is 10 mmol/L or more, the charge efficiency is improved at ambient temperature, and it is possible to obtain the effect of improving the charge acceptance to some degree. However, as a result of investigation conducted by the inventors of the present invention, it has been found that it is not possible to obtain the effect of improving the charge acceptance at low temperature, and the negative electrode utilization rate decreases.

### Solution to Problem

It is an object of the present invention to provide a lead acid battery in which the charge acceptance of the negative electrode at low temperature is improved, and the negative electrode utilization rate is increased.

An aspect of the present invention relates to a lead acid battery including: a positive electrode; a negative electrode; a separator interposed between the positive electrode and the negative electrode; and an electrolyte containing sulfuric acid, wherein the negative electrode includes a negative electrode active material, and a negative electrode grid that supports the negative electrode active material, the negative electrode grid contains tin in an amount of 0.1 mass % or more and 0.8 mass % or less, and the electrolyte contains aluminum ions at a concentration of 1 mmol/L or more and less than 10 mmol/L, and sodium ions at a concentration of 15 mmol/L or less.

### Advantageous Effects of Invention

According to the above-described aspect of the present invention, it is possible to improve the charge acceptance at low temperature in the lead acid battery. It is also possible to increase the negative electrode utilization rate.

Novel features of the present invention are specified in the appended claims. However, the configuration and the content of the present invention, together with other objects and features of the present invention, will be more fully understood from the detailed description given below with reference to the drawings.

### BRIEF DESCRIPTION OF DRAWINGS

FIG. 1 is a partial cutaway perspective view of a lead acid battery according to an embodiment of the present invention.

FIG. 2 is a front view of a positive electrode included in the lead acid battery shown in FIG. 1.

FIG. 3 is a front view of a negative electrode included in the lead acid battery shown in FIG. 1.

### DESCRIPTION OF EMBODIMENT

A lead acid battery according to one embodiment of the present invention includes a positive electrode, a negative electrode, a separator interposed between the positive electrode and the negative electrode, and an electrolyte containing sulfuric acid. The negative electrode includes a negative electrode active material, and a negative electrode grid that supports the negative electrode active material. The negative electrode grid contains 0.1 mass % or more and 0.8 mass % or less of tin. The electrolyte contains aluminum ions at a concentration of 1 mmol/L or more and less than 10 mmol/L, and sodium ions at a concentration of 15 mmol/L or less.

Conventionally, from the view point of increasing the charge acceptance, a proposal has been made to add 10 mmol/L or more of aluminum ions or the like to an electrolyte. It is generally known that aluminum ions act on the surface of lead sulfate and suppress the growth or high crystallization of lead sulfate, which is a degradation phenomenon of the negative electrode active material. Accordingly, the solubility of lead ions from lead sulfate is maintained, and the charge acceptance is improved as compared with the case where aluminum ions are not contained. However, as a result of investigation conducted by the inventors of the present invention, it has been found that when the concentration of aluminum ions is less than 10 mmol/L, an action and effect similar to those at ambient temperature are exhibited, but when the concentration aluminum ions is 10 mmol/L or more, although the charge acceptance at ambient temperature increases, the effect of improving the charge acceptance is gradually lost at low temperature. In general, in a system that does not contain aluminum ions, the solubility of lead ions from lead sulfate to sulfuric acid decreases at low temperature, and thus the charge acceptance decreases significantly. The reason is not clearly known, but it is considered that because the solubility of lead ions depends largely on temperature, the charge reaction is affected more significantly at low temperature than at ambient temperature. Accordingly, when the amount of aluminum ions is increased, no further effect is exhibited. Also, normally, tin is added to the negative electrode grid for the purpose of increasing the strength. However, when the amount of tin in the negative electrode grid is large, the hydrogen overvoltage of the negative electrode decreases, and side reactions such as generation of hydrogen increase, as a result of which the charge efficiency decreases, and the charge acceptance decreases.

In the present invention, it has been found that when tin is contained in an amount of 0.1 mass % or more and 0.8 mass % or less relative to the negative electrode grid, it is possible to suppress the degree of reduction in the hydrogen overvoltage particularly at low temperature. Thus, side reactions in the negative electrode at low temperature are suppressed. It has also been found that when the concentration of aluminum ions in the electrolyte is 1 mmol/L or more and less than 10 mmol/L, and the concentration of sodium ions in the electrolyte is 15 mmol/L or less, it is possible to ensure a high level of charge acceptance of the negative electrode particularly at low temperature. The reason is considered to be as follows. First, when the sulfuric acid concentration is as high as that at which the solubility of lead ions into sulfuric acid decreases, the growth of lead sulfate barely advances, and the effect of aluminum ions is unlikely to appear. Accordingly, when the hydrogen overvoltage of the negative electrode increases and side reactions are thereby suppressed, an increase of sulfuric acid concentration due to decomposition of water is suppressed, and thus the effect of aluminum ions is likely to appear. Furthermore, an increase in the amount of lead sulfate due to self-discharge of the negative electrode is suppressed, and the number of sites on which aluminum ions act can be maintained at a low level, as a result of which the charge acceptance is improved with a further reduced amount of aluminum ions. Also, when the concentration of sodium ions is increased, resistance components exhibit large influence at low temperature, which inhibits the dissolution of lead ions, and reduces the charge acceptance. Accordingly, by controlling the amount of tin in the negative electrode grid, the concentration of aluminum ions in the electrolyte, and the concentration of sodium ions in the electrolyte to be within the specific ranges, a high level of charge acceptance at low temperature is ensured.

Furthermore, in the present invention, by setting the concentration of aluminum ions and the concentration of sodium ions to be within the above-described ranges, the negative electrode utilization rate (negative electrode active material utilization rate) is also improved. When the negative electrode utilization rate is improved, an available negative electrode capacity increases. Accordingly, the increase in charge/discharge depth is suppressed, and the reduction in service life can be suppressed.

The concentration of aluminum ions and the concentration of sodium ions in the electrolyte are obtained by using an ICP emission spectroscopic analysis method. To be specific, a predetermined amount of electrolyte is collected from a battery at a temperature of 25° C., the collected electrolyte is diluted, and the amount of aluminum and the amount of sodium are quantified by using an ICP emission spectroscopic analysis method. Then, the obtained values are converted to concentrations (mmol/L) of aluminum ions and sodium ions in the electrolyte.

The term “ambient temperature” used in this specification refers to room temperature (for example, 20° C. to 35° C.). Likewise, the term “low temperature” refers to a temperature of 5° C. or less, or a temperature of 0° C. or less (for example, −20° C. to +5° C., or −20° C. to 0° C.).

Hereinafter, the lead acid battery according to the embodiment of the present invention will be described in further detail with reference to the drawings where appropriate.

### (Negative Electrode)

A negative electrode of a lead acid battery includes a negative electrode active material, and a negative electrode grid (an expanded grid, a casting grid, or the like) that supports the negative electrode active material (or a negative electrode material mixture containing the negative electrode active material). In general, the negative electrode has a plate shape, and thus the negative electrode is also called a “negative electrode plate”.

As the material of the negative electrode grid, for example, a lead alloy that contains tin is used. The amount of tin in the negative electrode grid is 0.8 mass % or less, and preferably 0.5 mass % or less, or 0.3 mass % or less. The amount of tin in the negative electrode grid is 0.1 mass % or more, and may be 0.2 mass % or more. The upper limit values and the lower limit values given above can be arbitrarily combined. The amount of tin in the negative electrode grid may be, for example, 0.1 to 0.5 mass %, 0.1 to 0.3 mass %, 0.2 to 0.8 mass %, 0.2 to 0.5 mass %, or 0.2 to 0.3 mass %. If the amount of tin in the negative electrode grid is above 0.8 mass %, the hydrogen overvoltage of the negative electrode decreases, and side reactions increase, as a result of which the charge efficiency decreases, and the charge acceptance decreases at ambient temperature and at low temperature. If the amount of tin in the negative electrode grid is less than 0.1 mass %, the strength of the negative electrode grid decreases, and thus the negative electrode easily degrades during charge and discharge.

As the lead alloy, for example, a lead alloy containing Ba, Ag, Ca, Al, Bi, and/or Sb may be used. From the viewpoint of mechanical strength and the like, it is preferable to use a lead alloy containing Ca. The Ca content in the lead alloy is, for example, 0.03 to 0.10 mass %.

The negative electrode grid may be composed of a plurality of lead alloy layers of different compositions were necessary.

The negative electrode active material generates a capacity through an oxidation-reduction reaction. As the negative electrode active material, lead (sponge lead, or the like) is used. The negative electrode active material in a charged state is sponge lead, but a negative electrode before being subjected to chemical formation is normally produced using a lead powder. When producing the negative electrode, the lead powder may contain lead oxide. The lead oxide is reduced to lead during a battery assembly stage (including a chemical formation process, or the like), a pre-charge/discharge or the like.

The negative electrode material mixture may further contain, in addition to the negative electrode active material, an expander (lignin and/or barium sulfate, or the like), a conductive agent (an electroconductive carbonaceous material such as carbon black, or the like) and/or a binding agent (a polymer binder, or the like). Also, the negative electrode may contain other known additives where necessary.

The negative electrode can be formed by filling or applying a paste containing a negative electrode active material (or a negative electrode material mixture paste) to a negative electrode grid, followed by drying, to produce a chemically unformed negative electrode, and then subjecting the unformed negative electrode to a chemical formation process. The paste contains, in addition to the negative electrode active material and other constituent components of the negative electrode material mixture, sulfuric acid and/or water, or the like a dispersion medium.

The drying step may be an aging/drying step of performing drying at a temperature higher than room temperature and at high humidity. The drying step can be performed under known conditions.

The chemical formation process can be performed by charging a lead acid battery in which chemically unformed positive and negative electrodes are immersed in a sulfuric acid-containing electrolyte within the battery container of a lead acid battery. The chemical formation process may be performed before the negative electrode is assembled into a battery or an electrode plate group where necessary.

### (Positive Electrode)

In general a positive electrode of a lead acid battery includes a positive electrode grid (an expanded grid, a casting grid, or the like), and a positive electrode active material (or a positive electrode material mixture) that is retained by the positive electrode grid. In general, the positive electrode has a plate shape, and thus the positive electrode is also called a “positive electrode plate”.

As the material of the positive electrode grid, it is possible to use lead or a lead alloy, for example. As the lead alloy, for example, a lead alloy containing Ba, Ag, Ca, Al, Bi Sb, and/or Sm may be used. From the viewpoint of ease of obtaining high levels of corrosion resistance and mechanical strength, it is preferable to use a lead alloy containing Ca and/or Sn. The Ca content in the lead alloy may be 0.01 to 0.1 mass %, and the Sn content in the lead alloy may be 0.05 to 3 mass %/o. The positive electrode grid may be composed of a plurality of lead alloy layers of different compositions where necessary. For example, from the viewpoint of suppressing degradation of the positive electrode active material, it is preferable to form a lead alloy layer containing Sb in a portion where the positive electrode active material is retained. The Sb content in the positive electrode grid may be, for example, 0.001 to 0.002 mass %.

The positive electrode active material generates a capacity through an oxidation-reduction reaction. As the positive electrode active material, lead oxide (PbO₂) is used. The positive electrode active material is normally used in the form of powder.

The positive electrode material mixture may contain, in addition to the positive electrode active material, a conductive agent (an electroconductive carbonaceous material such as carbon black, or the like) and/or a binding agent (polymer binder, or the like). The positive electrode may contain known additives where necessary.

The positive electrode can be formed in the same manner as the negative electrode is formed.

### (Separator)

As the separator, it is possible to use a microporous film or a fiber sheet (or mat), or the like, for example. As the polymer material that constitutes the microporous film or the fiber sheet, it is preferable to use a polymer material that has acid resistance. It is possible to use, for example, a polyolefin such as polyethylene or polypropylene. The fiber sheet may be made of a polymer fiber (a fiber made of any of the polymer materials listed above) and/or an inorganic fiber such as a glass fiber.

The separator may contain additives such as a filler and/or carbon where necessary.

### (Electrolyte)

The electrolyte contains sulfuric acid, and normally is an aqueous solution of sulfuric acid. The electrolyte contains aluminum ions and sodium ions.

The concentration of aluminum ions in the electrolyte is 1 mmol/L or more, and may be 5 mmol/L or more. The concentration of aluminum ions in the electrolyte is less than 10 mmol/L, and preferably 9.9 mmol/L or less, or 9.7 mmol/L or less, and more preferably 9.5 mmol/L or less. The upper limit values and the lower limit values given above can be arbitrarily combined. The concentration of aluminum ions in the electrolyte may be, for example, 1 to 9.9 mmol/L, 5 mmol/L or more and less than 10 mmol/L, 5 to 9.9 mmol/L, 1 to 9.7 mmol/L, or 1 to 9.5 mmol/L. If the concentration of aluminum ions in the electrolyte is 10 mmol/L or more, although the charge acceptance at ambient temperature increases, the charge acceptance at low temperature decreases. If the concentration of aluminum ions in the electrolyte is less than 1 mmol/L, it is not possible to sufficiently obtain the effect of improving the charge acceptance and the negative electrode active material utilization rate.

The concentration of sodium ions in the electrolyte is 15 mmol/L or less, and preferably 12 mmol/L or less, or 10 mmol/L or less. It is preferable that the electrolyte contains as little sodium ions as possible. However, it is actually difficult to bring the concentration of sodium ions to 0 mmol/L. The concentration of sodium ions in the electrolyte may be, for example, 1 mmol/L or more. If the concentration of sodium ions is above 15 mmol/L, the charge acceptance and the negative electrode active material utilization rate decrease, and in particular the charge acceptance at low temperature decreases significantly.

The electrolyte density is, for example, 1.1 to 1.35 g/cm³, and preferably 1.2 to 1.35 g/cm³. In this specification, the term “electrolyte density” refers to the density at a temperature of 20° C. With respect to the electrolyte density in the battery, it is preferable that the electrolyte density in the battery in a fully charged state (with an SOC of 99% or more) is within the above range. As used herein, the term “battery in a fully charged state” refers to a battery that has been subjected to chemical formation and is in a fully charged state.

The electrolyte may further contain metal cations other than aluminum ions. Examples of the metal cations include titanium ions, cesium ions, and/or scandium ions, and the like. Among these, it is preferable to use titanium ions. When the electrolyte contains such metal cations, sulfation of lead sulfate is further suppressed.

The electrolyte may contain a titanium compound in solid form where necessary. The titanium compound may be, for example, metatitanic acid, a titanic acid hydrate and/or a titanate.

A lead acid battery can be produced by housing an electrode plate group and an electrolyte in a battery case (battery container). The electrode plate group can be produced by stacking a plurality of positive electrodes and a plurality of negative electrodes one on top of each other, with a separator interposed between each pair of positive and negative electrodes. The separator is provided so as to be positioned between a positive electrode and a negative electrode. The separator may be a bag-like separator, or may be a sheet-like separator that is folded in half (into a U shape) so as to wrap around one of the electrodes, which is then stacked on the other electrode. A plurality of electrode plate assemblies may be housed in a battery container.

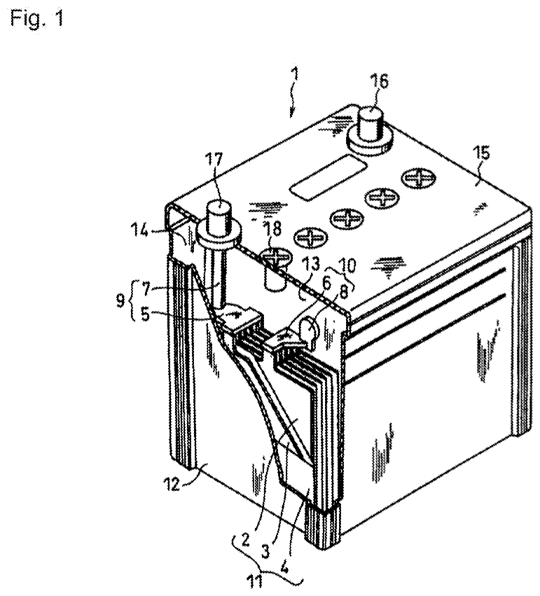

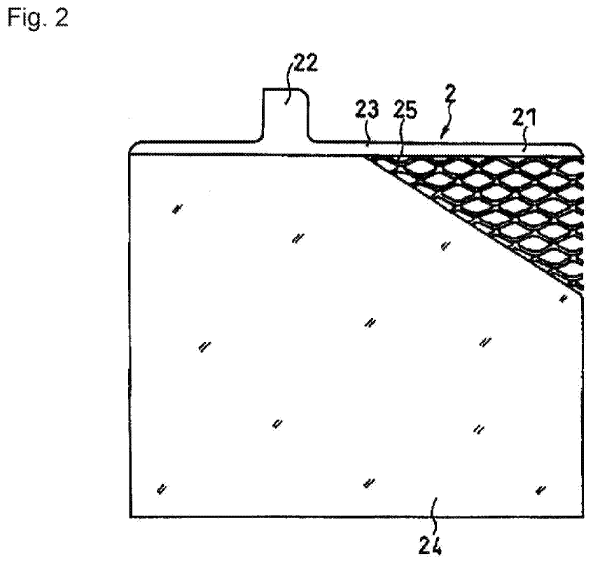

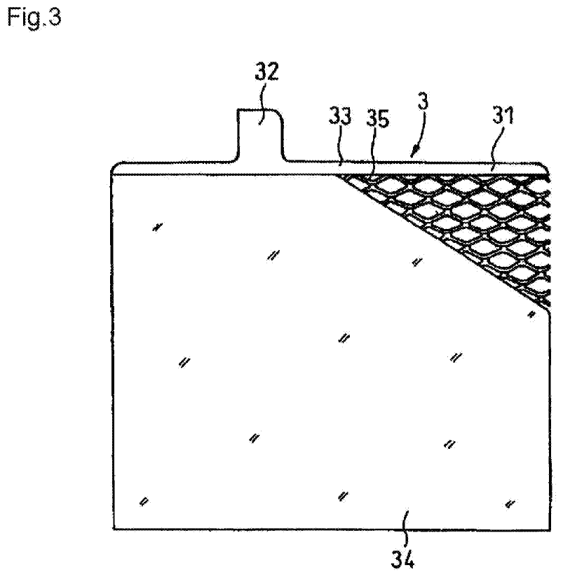

FIG. 1 is a partial cutaway perspective view of a lead acid battery according to an embodiment of the present invention. FIG. 2 is a front view of a positive electrode included in the lead acid battery shown in FIG. 1, and FIG. 3 is a front view of a negative electrode included in the lead acid battery shown in FIG. 1.

A lead acid battery includes an electrode plate group 11 and an electrolyte (not shown). The electrode plate group 11 and the electrolyte are housed in a battery container 12. To be more specific, the battery container 12 is divided into a plurality of cell compartments 14 by partition walls 13. In each cell compartment 14, one electrode plate group 11 is housed, and the electrolyte is also contained. The electrode plate group 11 is formed by stacking a plurality of positive electrodes 2 and a plurality of negative electrodes 3 with a separator 4 interposed between each pair of positive and negative electrodes.

Each positive electrode 2 includes a positive electrode grid that is provided with a tab portion (positive electrode tab portion) 22 that is integrated with the positive electrode grid. The positive electrode 2 is connected to a positive electrode connecting member 10 via the tab portion 22. The positive electrode connecting member 10 includes a positive electrode strap 6 that is connected to the tab portions 22 of the positive electrode grids, and a positive electrode connector 8 or a positive electrode post that is provided on the positive electrode strap 6. The positive electrode strap 6 connects the plurality of positive electrodes 2 in parallel. Likewise, each negative electrode 3 includes a negative electrode grid that is provided with a tab portion (negative electrode tab portion) 32 that is integrated with the negative electrode grid. The negative electrode 3 is connected to a negative electrode connecting member 9 via the tab portion 32. The negative electrode connecting member 9 includes a negative electrode strap 5 that is connected to the tab portions 32 of the negative electrode grids, and a negative electrode post 7 or a negative electrode connector that is provided on the negative electrode strap 5. The negative electrode strap 5 connects the plurality of negative electrodes 3 in parallel. In the example shown in the diagram, on one end portion of the battery container 12, the positive electrode connector 8 is connected to the positive electrode strap 6, and the negative electrode post 7 is connected to the negative electrode strap 5. On the other end portion of the battery container 12, the positive electrode post is connected to the positive electrode strap 6, and the negative electrode connector is connected to the negative electrode strap 5.

In each cell, the positive electrode strap, the negative electrode strap, and the entire electrode plate group are immersed in the electrolyte.

A cover 15 is attached to an opening of the battery container 12. The cover 15 is provided with a positive electrode terminal 16 and a negative electrode terminal 17. The positive electrode connector 8 is connected to the negative electrode connector that is provided continuously to the negative electrode strap on electrode plate assemblies 11 housed in adjacent cell compartments 14 through a through-hole formed in each partition wall 13. Accordingly, each electrode plate group 11 is connected in series to an electrode plate group 11 housed in an adjacent cell compartment 14. On one end portion of the battery container 12, the negative electrode post 7 is connected to the negative electrode terminal 17. On the other end portion, the positive electrode post is connected to the positive electrode terminal 16. A gas discharge valve 18 is attached to an electrolyte injection inlet provided in the cover 15. The gas discharge valve 18 includes a gas discharge outlet for discharging a gas generated inside the battery to the outside of the battery.

Each positive electrode 2 includes a positive electrode grid 21 that has a tab portion 22, and a positive electrode active material layer (or a positive electrode material mixture layer) 24 that is retained by the positive electrode grid 21. The positive electrode grid 21 is an expanded grid that includes an expanded mesh 25 for retaining the positive electrode active material layer 24, a frame rib 23 that is provided on an upper end portion of the expanded mesh 25, and a tab portion 22 that is provided continuously to the frame rib 23.

Likewise, each negative electrode 3 includes a negative electrode grid 31 that has a tab portion 32, and a negative electrode active material layer (or a negative electrode material mixture layer) 34 that is retained by the negative electrode grid 31. The negative electrode grid 31 is an expanded grid that includes an expanded mesh 35 for retaining the negative electrode active material layer 34, a frame rib 33 that is provided on an upper end portion of the expanded mesh 35, and a tab portion 32 that is provided continuously to the frame rib 33.

It is preferable that the positive electrode connecting member and the negative electrode connecting member are made of lead or a lead alloy. As the lead alloy, it is possible to select from the lead alloys listed as examples of the material of the positive electrode grid as appropriate. In the case where the negative electrode tab portion contains bismuth, the hydrogen overvoltage is easily increased, and the charge efficiency is likely to be improved as compared with a negative electrode grid containing tin.

The negative electrode tab portion can be formed integrally with the negative electrode grid by being formed at the same time when the negative electrode grid is formed by cutting. Here, the negative electrode grid and the negative electrode tab portion may be formed by using a lead alloy containing tin and bismuth. Alternatively, the negative electrode grid and the negative electrode tab portion may be formed by using a lead alloy containing tin, and a lead alloy sheet containing bismuth may be attached to the surface of the negative electrode tab portion so as to cause the negative electrode tab portion to contain bismuth. In this case, the negative electrode tab portion contains bismuth on its surface layer.

The amount of bismuth in the surface layer of the negative electrode tab portion is, for example, 10 to 30 mass %, and may be 5 to 50 mass %. When the amount of bismuth in the negative electrode tab portion is within the above range, the hydrogen overvoltage is more easily increased, and the effect of improving the charge efficiency is likely to be obtained.

The lead alloy that constitutes the negative electrode tab portion may further contain, in addition to bismuth, Ba, Ag, Ca, Al, Sb, and/or Sn (inter alia, Ag, Ca, and/or Sn).

### EXAMPLES

Hereinafter, the present invention will be described specifically by way of examples and comparative examples. However, it is to be noted that the present invention is not limited to the examples given below.

### Example 1

### (1) Production of Positive Electrode

A positive electrode 2 as shown in FIG. 2 was produced in the following procedure.

A positive electrode material mixture-containing paste was obtained by mixing a raw material powder (a mixture of lead and a lead oxide), water, and dilute sulfuric acid (with a density of 1.40 g/cm³) at a mass ratio of 100:15:5.

A plate material was produced by subjecting a terary alloy (Pb—Ca—Sn alloy) containing lead, calcium and tin to continuous slab casting and multi-stage rolling. After that, a Pb—Sb alloy containing 2.5 mass % of antimony was attached onto both surfaces of the plate material, and then subjected to expanding processing. A positive electrode grid 21 integrated with a positive electrode tab portion 22 was thereby obtained. The tin content and the calcium content in the Pb—Ca—Sn alloy were adjusted to 1.8 mass % and 0.05 mass %, respectively. At this time, the antimony content in the positive electrode grid was 0.025 mass %.

The positive electrode material mixture-containing paste was filled into the expanded mesh 25 of the positive electrode grid, and then aged/dried, and thereby a chemically unformed positive electrode 2 (with a length of 115 mm, a width of 137.5 mm, and a thickness of 1.5 mm) was obtained in which the positive electrode material mixture was retained by the positive electrode grid 21.

### (2) Production of Negative Electrode

A negative electrode 3 as shown in FIG. 3 was produced in the following procedure.

A negative electrode material mixture-containing paste was obtained by mixing a raw material powder (a mixture of lead and a lead oxide), water, dilute sulfuric acid (with a density of 1.40 g/cm³), lignin, barium sulfate, and carbon black at a mass ratio of 100:12:7:1:0.1:0.5.

A plate material was produced from a Pb—Ca—Sn alloy (with a tin content of 0.25 to 0.90 mass %, and a calcium content of 0.07 mass %) in the same manner as the positive electrode grid was produced. After that, a lead alloy sheet containing bismuth was attached to both surfaces of a portion of the plate material that would function as a negative electrode tab portion. After that, the plate material was further rolled so as to form a 10 μm thick surface layer portion containing 23 mass % of bismuth. As the lead alloy sheet containing bismuth, a sheet made of a binary alloy (Pb—Bi alloy) containing lead and bismuth was used. After that, the plate material was subjected to expanding processing. A negative electrode grid 31 (with a thickness of 1.4 mm) integrated with a negative electrode tab portion 32 was thereby obtained.

The negative electrode material mixture-containing paste was filled into the expanded mesh of the negative electrode grid 31, and through the same method as described above, a chemically unformed negative electrode 3 (with a length of 115 mm, a width of 137.5 mm, and a thickness of 1.6 mm) was obtained in which the negative electrode material mixture was supported by the negative electrode grid 31.

### (3) Evaluation

A test cell was produced in the following procedure (a). The produced test cell was subjected to the following evaluations (b) and (c). Here, 1.0 C of a test cell was calculated from the theoretical capacity of the test cell.

### (a) Production of Test Cell

The positive electrode plate and the negative electrode plate produced in (1) and (2) above were cut into pieces, each piece having a length of 60 mm and a width of 40 mm, so as to obtain one negative electrode plate and two positive electrode plates. The negative electrode plate and the two positive electrode plates were stacked such that the negative electrode plate was placed between the two positive electrode plates with a separator (a microporous film made of polyethylene with a thickness of 0.2 mm and a width of 44 mm) interposed therebetween. In this way, an electrode plate group was formed. At this time, the separator 4 was folded in half such that the negative electrode plate was placed between the folds.

The obtained electrode plate group was sandwiched by acrylic plates from both sides, and fixed. Next, a lead rod was welded to each of the negative electrode plate and the two positive electrode plates so as to form a negative electrode terminal, and a positive electrode terminal. The electrode plate group was placed in a polypropylene container, a predetermined amount of sulfuric acid with a density of 1.20 g/cm³ was injected, and chemical formation was performed. The sulfuric acid in the cell used in the chemical formation was removed, and an aqueous solution of sulfuric acid in which aluminum sulfate and sodium sulfate were dissolved was additionally injected as an electrolyte. At this time, the amount and concentration of each component were adjusted such that the electrolyte density in the produced battery was 1.28 g/cm³, and the concentration of aluminum ions and the concentration of sodium ions had values shown in Table 1. In this way, a test cell (1.25 Ah, 2 V) was produced.

### (b) Measurement of Concentrations of Aluminum Ions and Sodium Ions in Electrolyte in Batter

The concentration of aluminum ions and the concentration of sodium ions in the electrolyte were obtained by collecting a predetermined amount of electrolyte from the battery at a temperature of 25° C., diluting the collected electrolyte, quantifying the amount of aluminum and the amount of sodium by using an ICP emission spectroscopic analysis method, and converting the obtained values to concentrations (mmol/L) in the electrolyte.

### (c) Charge Acceptance

The test cell that has undergone chemical formation was charged under the following conditions while adjusting the SOC of the test cell. The charge acceptance was compared based on the amount of electricity obtained during 10 seconds after charging was started.

Discharge (SOC adjustment): constant current, 0.2 C, 30 minutes

Break: 12 hours

Charging (charge acceptance): constant current (3 C)−constant voltage (2.4 V, maximum current 3 C), 60 seconds

Temperature: 25° C. or −10° C.

### (d) Negative Electrode Active Material Utilization Rate

Another test cell that has undergone chemical formation, which was different from the test cell described above, was subjected to a constant current discharge at 25° C. at a rate of 0.2 C to a cutoff voltage of 1.7 V, and the cell capacity at this time was measured Based on the cell capacity, the negative electrode active material capacity (m Ah/g) was determined. 50% of the theoretical capacity of metal lead contained in the negative electrode active material of a cell was defined as cell theoretical capacity, and the proportion (%) of the negative electrode active material capacity (m Ah/g) to the cell theoretical capacity was defined as the negative electrode active material utilization rate.

### Examples 2 to 5, and Comparative Examples 1 to 6

Lead acid batteries were produced and evaluated in the same manner as in Example 1, except that, in (3) of Example 1, the amount of aluminum sulfate and/or the amount of sodium sulfate were adjusted such that the concentration of aluminum ions and the concentration of sodium ions in each produced battery had values shown in Table 1.

Examples 6 and 7, and Comparative Example 7 Negative electrode grids were produced in the same manner as in Example 1, except that, in (2) of Example 1, Pb—Ca—Sn alloys containing tin in amounts shown in Table 1 were used. Then, lead acid batteries were produced and evaluated in the same manner as in Example 1, except that the obtained negative electrode grids were used.

The results obtained in the examples and the comparative examples are shown in Table 1. In Table 1, Examples 1 to 7 are represented by A1 to A7, and Comparative Examples 1 to 7 are represented by B1 to B7. Al ion concentration and Na ion concentration are the concentration of Al ions and the concentration of Na ions in the electrolyte contained in each battery. Charge acceptance and negative electrode active material utilization rate are each expressed by the ratio when the value of Comparative Example 1 is taken as 100.

TABLE 1

| | | | Sn | | | Negative |
|---|---|---|---|---|---|---|
| | | | content in | | | electrode |
| | Al ion | Na ion | negative | | | active |
| | concen- | concen- | electrode | Charge | | material |
| | tration | tration | grid | acceptance | | utilization |
| | (mmol/L) | (mmol/L) | (mass %) | 25° C. | −10° C. | rate (%) |
| B1 | 0.0 | 10.0 | 0.25 | 100 | 100 | 100 |
| A1 | 1.0 | 10.0 | 0.25 | 101 | 120 | 100 |
| A2 | 5.0 | 10.0 | 0.25 | 102 | 130 | 101 |
| A3 | 9.5 | 10.0 | 0.25 | 104 | 150 | 103 |
| A4 | 9.5 | 5.0 | 0.25 | 104 | 155 | 103 |
| A5 | 9.5 | 1.7 | 0.25 | 104 | 165 | 103 |
| B2 | 10.5 | 10.0 | 0.25 | 104 | 110 | 99 |
| B3 | 11.0 | 10.0 | 0.25 | 104 | 108 | 98 |
| B4 | 40.0 | 10.0 | 0.25 | 110 | 110 | 96 |
| B5 | 100.0 | 10.0 | 0.25 | 120 | 90 | 96 |
| B6 | 9.5 | 20.0 | 0.25 | 100 | 80 | 100 |
| A6 | 9.5 | 10.0 | 0.50 | 104 | 140 | 103 |
| A7 | 9.5 | 10.0 | 0.80 | 104 | 130 | 103 |
| B7 | 9.5 | 10.0 | 0.90 | 100 | 100 | 102 |

As shown in Table 1, in the examples, charge acceptance improved significantly not only at ambient temperature (25° C.) but also at low temperature (−10° C.) as compared with the comparative examples. Also, in the examples, high negative electrode active material utilization rates were obtained.

Although the present invention has been described in terms of the presently preferred embodiment, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The lead acid battery according to the present invention has excellent charge acceptance not only at ambient temperature but also at low temperature particularly when used in a use mode in which the lead acid battery in an undercharge state is repeatedly charged and discharged. Also, the lead acid battery according to the present invention has a high negative electrode active material utilization rate. Accordingly, the lead acid battery according to the present invention is suitable for use in a vehicle on which an idle stop system or a regenerative braking system is mounted, and the like.

### REFERENCE SIGNS LIST

1 Lead Acid Battery
2 Positive Electrode
3 Negative Electrode
4 Separator
5 Negative Electrode Strap
6 Positive Electrode Strap
7 Negative Electrode Post
8 Positive Electrode Connector
9 Negative Electrode Connecting Member
10 Positive Electrode Connecting Member
11 Electrode Plate Group
12 Battery Container
13 Partition Wall
14 Cell Compartment
15 Cover
16 Positive Electrode Terminal
17 Negative Electrode Terminal
18 Gas Discharge Valve
21 Positive Electrode Grid
22, 32 Tab Portion
23, 33 Frame Rib
24 Positive Electrode Active Material Layer
25, 35 Expanded Mesh
31 Negative Electrode Grid
34 Negative Electrode Active Material Layer

1. A lead acid battery comprising:
a positive electrode;
a negative electrode;
a separator interposed between the positive electrode and the negative electrode; and
an electrolyte containing sulfuric acid,
wherein the negative electrode includes a negative electrode active material, and a negative electrode grid that supports the negative electrode active material,
the negative electrode grid contains tin in an amount of 0.1 mass % or more and 0.8 mass % or less, and
the electrolyte contains aluminum ions at a concentration of 1 mmol/L or more and less than 10 mmol/L, and sodium ions at a concentration of 15 mmol/L or less.

2. The lead acid battery in accordance with claim 1,
wherein the concentration of aluminum ions in the electrolyte is 1 mmol/L or more and 9.5 mmol/L or less, and
the concentration of sodium ions is 1 mmol/L or more and 10 mmol/L or less.

3. The lead acid battery in accordance with claim 1,
wherein the amount of tin in the negative electrode grid is 0.1 mass % or more and 0.5 mass % or less.

4. The lead acid battery in accordance with claim 1,
wherein the lead acid battery comprises an electrode plate group and the electrolyte,
the electrode plate group includes:
a plurality of the positive electrodes;
a positive electrode strap that connects the plurality of the positive electrodes in parallel;
a plurality of the negative electrodes;
a negative electrode strap that connects the plurality of the negative electrodes in parallel; and
the separators that are interposed between the positive and negative electrodes that are adjacent to each other,
the negative electrodes each further includes a negative electrode tab portion that is integrated with the negative electrode grid and that connects the negative electrode to the negative electrode strap, and
the negative electrode tab portion contains bismuth.

5. The lead acid battery in accordance with claim 2,
wherein the amount of tin in the negative electrode grid is 0.1 mass % or more and 0.5 mass % or less.

6. The lead acid battery in accordance with claim 2,
wherein the lead acid battery comprises an electrode plate group and the electrolyte,
the electrode plate group includes:
a plurality of the positive electrodes;
a positive electrode strap that connects the plurality of the positive electrodes in parallel;
a plurality of the negative electrodes;
a negative electrode strap that connects the plurality of the negative electrodes in parallel; and
the separators that are interposed between the positive and negative electrodes that are adjacent to each other,
the negative electrodes each further includes a negative electrode tab portion that is integrated with the negative electrode grid and that connects the negative electrode to the negative electrode strap, and
the negative electrode tab portion contains bismuth.

7. The lead acid battery in accordance with claim 3,
wherein the lead acid battery comprises an electrode plate group and the electrolyte,
the electrode plate group includes:
a plurality of the positive electrodes;
a positive electrode strap that connects the plurality of the positive electrodes in parallel;
a plurality of the negative electrodes;
a negative electrode strap that connects the plurality of the negative electrodes in parallel; and
the separators that are interposed between the positive and negative electrodes that are adjacent to each other,
the negative electrodes each further includes a negative electrode tab portion that is integrated with the negative electrode grid and that connects the negative electrode to the negative electrode strap, and
the negative electrode tab portion contains bismuth.

8. The lead acid battery in accordance with claim 5,
wherein the lead acid battery comprises an electrode plate group and the electrolyte,
the electrode plate group includes:
a plurality of the positive electrodes;
a positive electrode strap that connects the plurality of the positive electrodes in parallel;
a plurality of the negative electrodes;
a negative electrode strap that connects the plurality of the negative electrodes in parallel; and
the separators that are interposed between the positive and negative electrodes that are adjacent to each other,
the negative electrodes each further includes a negative electrode tab portion that is integrated with the negative electrode grid and that connects the negative electrode to the negative electrode strap, and
the negative electrode tab portion contains bismuth.
